(19) United States
(12) Patent Application Publication
(10) Pub. No.: US 2009/0315283 A1
(43) Pub. Date: Dec. 24, 2009

(54) MOBILE CARRIAGE SUPPORTING A TOOL OR IMPLEMENT

(76) Inventor: Daniel Watkins, Greenup, KY (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 12/145,014

(22) Filed: Jun. 24, 2008

(51) Int. Cl. B62B 3/10

(52) U.S. Cl. 280/35

(57) ABSTRACT

A mobile carriage for supporting a tool, the mobile carriage comprising a first frame and a second frame, the frames generally having a Y-shape, with a support coupling the first frame and the second frame. The support elevates an end of the second frame. The second frame has at least one retaining member positioned along the second frame, the at least one retaining member retaining the tool in place and relative to the second frame. A plurality of moving means positioned at terminal ends of the first frame. The mobile carriage includes a handle depending from one of the first frame or the second frame. The mobile carriage may further include a control altering the distance between the first frame and the second frame.

### FIELD OF INVENTION

This application discloses claims and embodiments generally related to a mobile support carriage, and more particularly, a mobile carriage supporting a tool or implement facilitating the ease of use of the tool or implement, especially over an uneven surface.

### BACKGROUND OF THE INVENTION

Home care, including yard and lawn care, can be difficult work, depending upon the terrain and other factors. Many parts of the country have particular rough and uneven terrain, so that mowing and weed-trimming work become even more difficult. Weed-trimming, in particular, is difficult on the neck, back, arms and shoulders, generally because of the size, weight and general awkwardness of the device. Improvements in this area are provided, but are usually less than satisfactory for one or more reasons. Thus, it is advantageous to have an apparatus or device having the elements and features disclosed herein, generally reducing the work burden on the user, and having an apparatus that supports the tool in the proper position while also reducing the weight and the stress that is imparted on the user.

Several products and inventions have been proposed in order to achieve these goals. The art includes many such attempts and improvements. However, the art does not appear to disclose the combination of elements and features disclosed herein, including the novel combination of elements and/or materials disclosed hereinafter. In particular, the art includes variations on hand trucks or four-wheel dollies, golf-bag push or pull carts, and the like. As such, an improvement to the tool or implement carriage art is presently available and is desirable and useful.

This application presents claims and embodiments that fulfill a need or needs not yet satisfied by the products and inventions previously or presently available, including the example of the art presented above. In particular, the claims and embodiments disclosed herein describe a mobile carriage supporting a tool or implement and comprises unanticipated and nonobvious combination of features distinguished from the products and inventions preexisting in the art. The applicant is unaware of any product, disclosure or reference that discloses the features of the claims and embodiments disclosed herein, and as more fully described below.

### SUMMARY OF THE INVENTION

In accordance with one embodiment, a mobile carriage for a lawn-care tool comprising a first frame and a second frame; a support coupling the first frame and the second frame, the support elevating an end of the second frame; at least one retaining member positioned along the second frame, the at least one retaining member retaining the tool; a plurality of moving means positioned at terminal ends of the first frame; a handle depending from one of the first frame or the second frame; and a control altering the distance between the first frame and the second frame.

In one embodiment, each of the first frame and the second frame comprises a Y-shape, the first frame and the second frame having a plurality of indexing apertures for selectively adjusting the length of each frame.

In one embodiment, the support comprises an indexing guide having a plurality of indices vertically aligned to receive a bar depending from the second frame. In one aspect of the embodiment, the support comprises a pair of struts and a transverse bar supported by the struts, the transverse bar received through one of a plurality of indices formed in a centrally aligned post. In another aspect of the embodiment, the transverse bar may be received through one of a plurality of indices formed in struts.

In one embodiment, the at least one retaining member comprises a base segment and a cover segment, each segment having a relief receiving the shaft of the tool, the base segment and the cover segment coupled to one another. The at least one retaining member may comprise a channel formed in the underside thereof receiving a retractable post, wherein the diameter is tapered. The retractable post comprises an elongated post having a boss and an outwardly biased spring retaining the post in position, the elongated post having a tapered form, wherein the smaller diameter portion of the channel retains the wider diameter portion of the elongated post, thereby retaining the retractable post therein, wherein the retractable post is urged against the outwardly biased spring to urge the wider diameter portion from the channel, thereby releasing the at least one retaining member from the second frame. In another aspect of the embodiment, the mobile carriage may further comprise a second retaining member, the second retaining member comprising a base segment and a cover segment, each segment having a relief receiving the shaft of the tool, and having at least one leg and one opening for coupling with a transverse fastener coupling a pair of arms of the second frame.

In one embodiment, the handle comprises a boom coupled to the second frame via a sleeve and lock inserted through a first pair of wings having right handed and left handed elements, and an elongated rod coupled to the second frame at a second pair of wings having right handed and left handed elements. In another aspect of the embodiment, the handle comprises a second elongated rod coupled to the first frame via a pair of upstanding wings and a pair of articulating wings, the pair of articulating wings having right handed and left handed elements.

In one embodiment, the control comprises two telescoping bodies interconnected between the first frame and the second frame, the control having a crank communicating with a threaded member for raising and lowering the profile of the second frame relative to the first frame.

In one embodiment, the mobile carriage further comprises a pedal for downwardly urging a terminal end of the tool, wherein the pedal comprises an engagement area formed at an end of a linearly elongated T-shaped tube, the T-shaped tube coupled with at least one support shaft, the at least one support shaft coupled to a pair of arms of the first frame, the pedal articulating downward about the at least one support shaft. In another aspect of the embodiment, the mobile carriage further comprises a spring assembly coupled to the first frame and the T-shaped tube, the spring assembly having an inwardly biased spring having an end of the spring coupled to the T-shaped tube and having an opposing end of the spring coupled to a suspended yoke.

### BRIEF DESCRIPTION OF THE DRAWINGS

FIG. 1 is a perspective view of a mobile carriage supporting a tool or implement;

FIG. 2 is a perspective view of an alternate embodiment of the mobile carriage;

FIG. 3 is a perspective view of an alternate embodiment of the mobile carriage, wherein the handle include a second elongated rod coupled to the first frame;

FIG. 4 is a perspective view of the control and the pedal as interconnected with the frame members;

FIG. 5 is a perspective view of the stem of the second frame member and the mechanical couplers utilized for holding the shaft of the tool or implement and its interconnection with the second frame member;

FIG. 6 is a perspective view of one embodiment of the index guide;

FIG. 7 is a perspective view of an alternate embodiment of FIG. 6;

FIG. 8 is an enlarged view of a control;

FIG. 9 is a perspective view of the wheel axles

FIG. 10, FIG. 11 and FIG. 12 are perspective views of the mechanical couplers and the retractable post and support; and

FIG. 13 is a perspective view of the collars housed within the reliefs of the couplers of FIG. 10 and FIG. 11, respectively.

### DESCRIPTION OF THE EMBODIMENTS

Generally, a mobile carriage 50 is disclosed and depicted, the carriage 50 having frame members 52 and 54 interconnected or coupled by a support 56. The carriage 50 further includes mechanical couplers 58 and 60 receiving and holding a tool or implement, the couplers 58 and 60 coupled to the frame member 54. The carriage 50 may also include a handle 62 for aiding in controlling the carriage 50 during operation. The carriage 50 may also include a pedal 64 for temporarily changing the height of the tool or implement. Furthermore, the carriage 50 may include a control 66 for finely adjusting the height of the tool or implement.

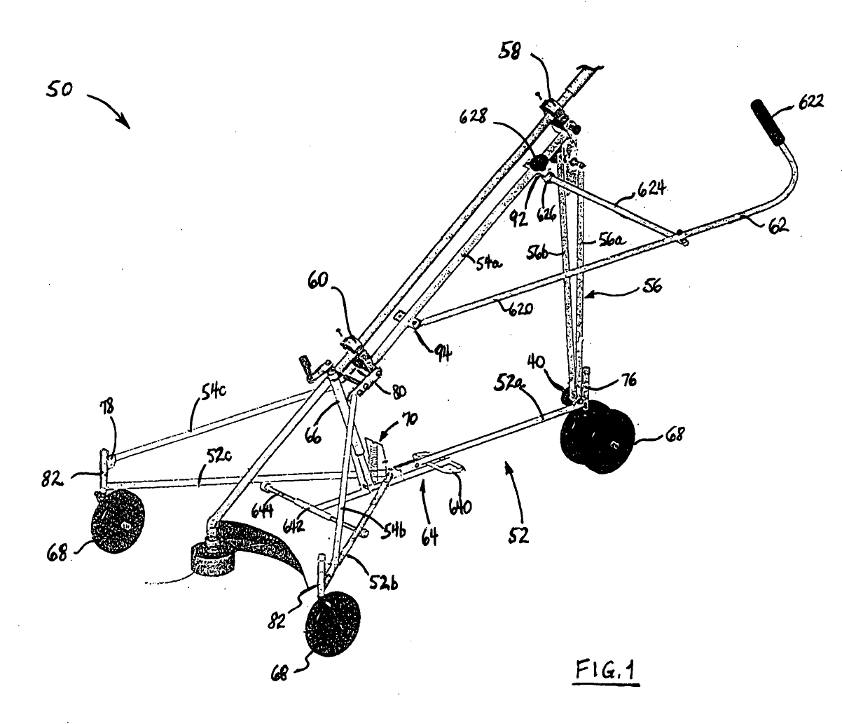

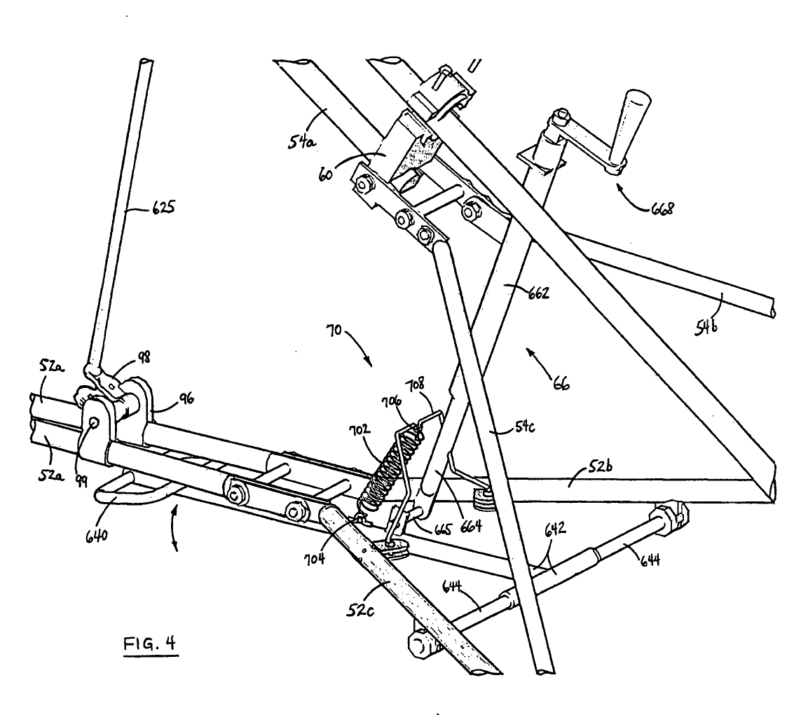

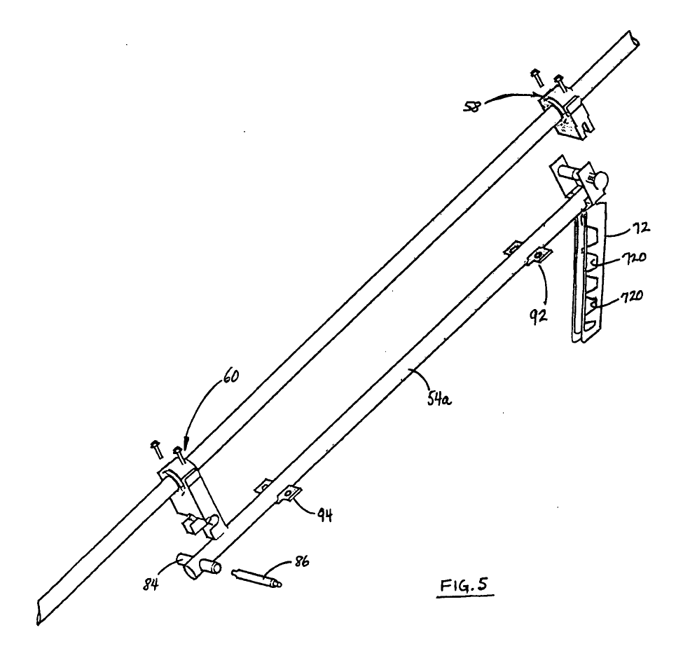

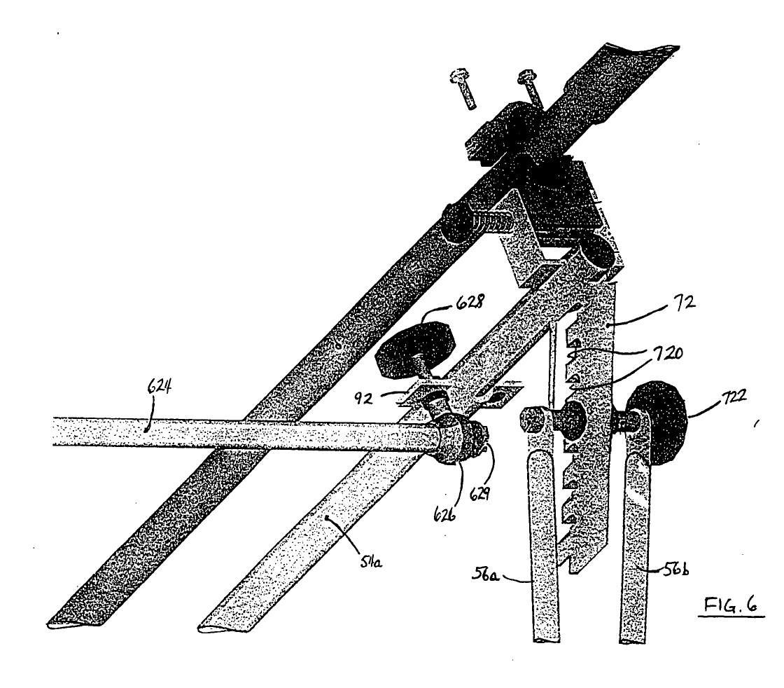

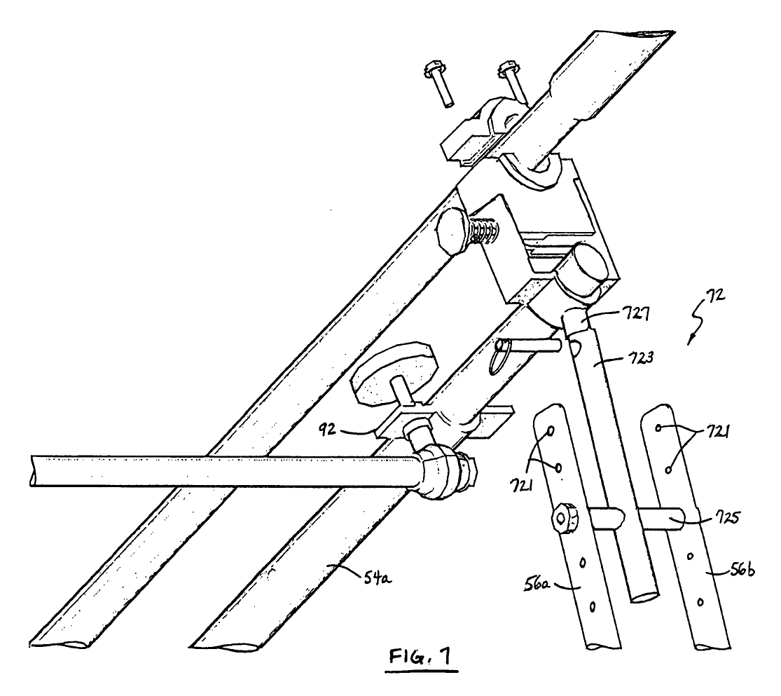

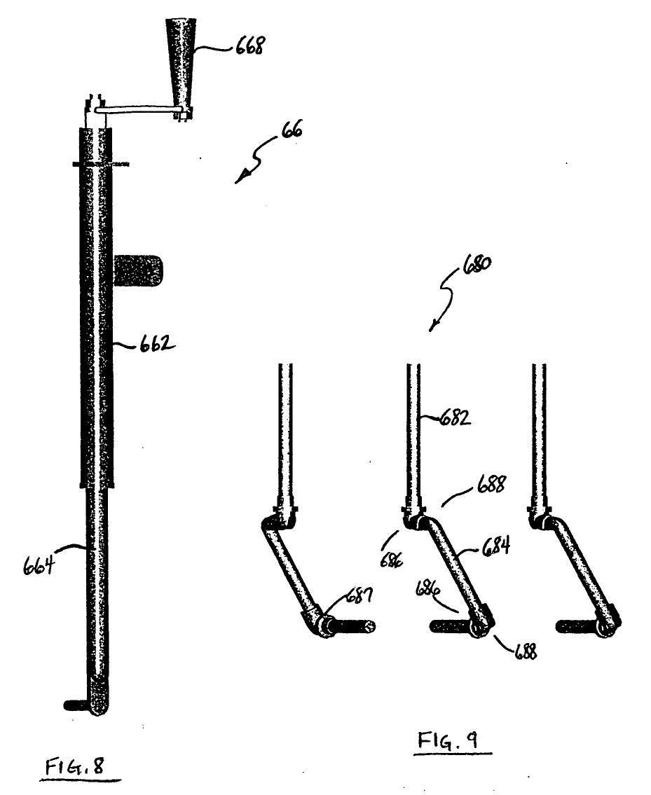

With reference to the figures, specifically FIG. 1 through FIG. 13, and in accordance with one embodiment, a mobile carriage (or also “apparatus”) 50 is disclosed, the mobile carriage 50 for supporting a tool or implement. The mobile carriage 50 comprises a first frame member 52 and a second frame member 54, the frame members 52 and 54 coupled to one another. The first frame member 52 serves as the mobile base of the apparatus 50 in having a plurality of wheels, skids or other movable elements 68 (depicted as wheels in the figures by way of example only) coupled to the first frame member 52. The second frame member 54 serves to retain and position the tool or implement. The second frame member 54 is selectively variable via a support 56 coupling the first frame member 52 and the second frame member 54 at the rear of the apparatus 50. The first frame member 52 and the support 56 may be coupled via an articulating joint. The second frame member 54 may be further selectively variable via a control 52. The mobile carriage 50 may further include a handle 62 coupled to the second frame member 54. The mobile carriage 50 may further include a pedal 64 that lowers an end of the tool or implement if the pedal 64 is depressed, and returns to position when the pedal 64 is released.

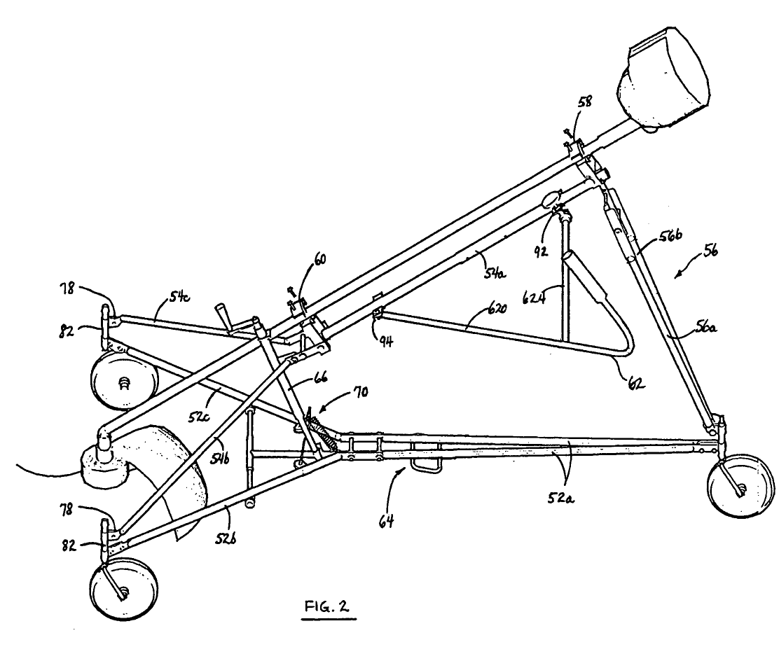

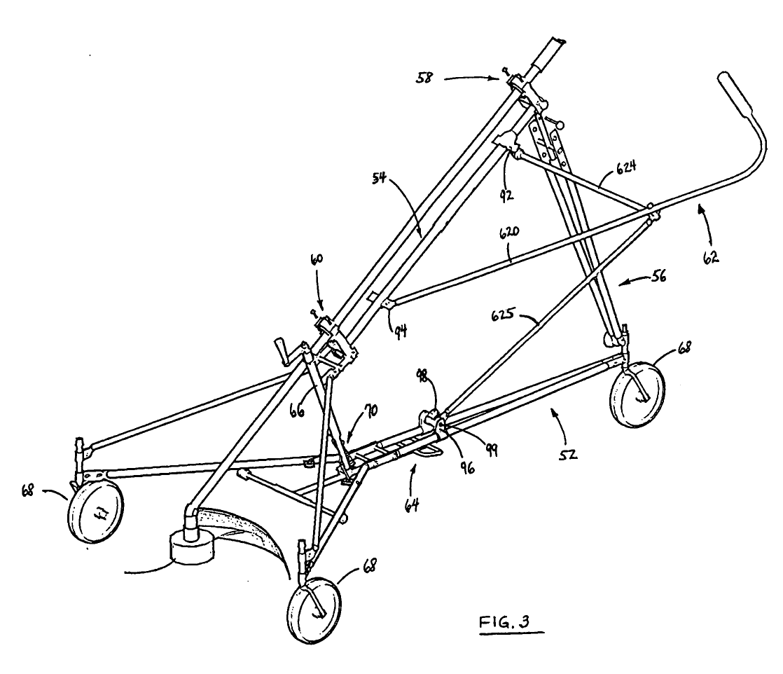

In one embodiment, the first frame member 52 generally comprises a Y-shape, with the stem 52a forming the rear-portion of the member 52, and the two arms 52b, 52c depending from the stem 52a forming the front-portion of the member 52. In one embodiment, as depicted in FIG. 1, the stem 52a generally comprises a single linearly elongated member coupled with the arms 52b, 52c via a junction, whereby the coupling is achieved by mechanical fasteners (e.g. threaded bolts with nuts), by welding, or by other similar ways to couple the member 52 components. In another embodiment, as depicted in FIG. 2 and FIG. 3, the stem 52a may be formed of a pair of linearly elongated members generally convergent at its rear terminus and slightly divergent at its front terminus. The pair of linearly elongated members may be supported by bolts or fasteners (threaded or unthreaded) that also operate as spacers to support the divergence at the forward terminus. It is envisioned that this embodiment may provide additional support and stability to the apparatus 50, helping to evenly distribute the balance of the frame member 52.

The movable elements 68 are coupled to the terminal ends of the stem 52a and arms 52b, 52c, thereby providing a member 52 having two points of contact with a surface at or near the front of the apparatus (52b, 52c and corresponding movable elements 68) and one point of contact with the surface at or near the rear of the apparatus (52a and corresponding movable element(s) 68). As depicted as an example, the movable elements 68 are shown as wheels. Each wheel, or combination of wheels, 68 may be coupled at or near the respective terminal ends via a variety of mechanisms or devices. Each wheel, or combination of wheels, 68 may be coupled to provide 360 degrees of rotation to the wheel(s) 68, thereby imparting 360 degrees of rotation to the frame member 52 and the apparatus 50 collectively.

As depicted in FIG. 1, in one particular embodiment, each wheel 68 may be coupled to the first frame member 52 via a wheel assembly 680 comprising a linear shaft 682 and a curvilinear shaft 684 having a bushing 686 disposed therebetween. The curvilinear shaft 684 may comprise at least one bend 688, and may further include an additional bend (or bends). At each additional bend 688, a bushing 686 is utilized. As depicted, the linear shaft 682 is coupled with or inserted into a channel of a post formed at a terminal end of the first frame member 52. A flange 687 on the bushing 686 abuts the bottom of the channel or post, inhibiting further vertical movement of the linear shaft 682, but allowing 360 degrees of rotation to the assembly 680 and the corresponding wheel 68. The first bend 688 offsets the axis of the curvilinear shaft 684 from the axis of the linear shaft 682, and disposes the curvilinear shaft at an angle away from the vertical alignment of the linear shaft. At the opposing end of the curvilinear shaft 684, a second bend 688 is formed for insertion into and through the wheel 68, usually at the center thereof, though the position may be variable as required. The end of the assembly 680 at the wheel 68 is secured thereon by a cap, threaded nut or other suitably similar mechanical element 689. Generally, each wheel 68 is similarly coupled to the first frame member 52. If a dual wheel is used, such as at the rear of the apparatus 50, the assembly 680 is slightly altered so that a linear and a non-vertical shaft is disposed between the dual wheels, with bushings thereon, and a horizontally disposed shaft is inserted into and through the center of the wheels and secured by a cap, threaded nut or other mechanical element at each end thereof. Each wheel, or combination of wheels, 68 may comprise a cover for preventing the build-up of material thereon.

The first frame member 52 may include a pedal 64 coupled thereto. The pedal 64 is coupled in a manner so as to articulate or pivot from a point of coupling, thereby lowering the end of the tool or implement retained by the apparatus 50. In one embodiment, the pedal 64 has an engagement area 640 formed at the end of a linearly elongated T-shaped tube 642. The T-shaped tube 642 receives and retains the ends of two support shafts 644, or alternatively, a single support shaft 644 passes through the T-shaped tube 642. In either embodiment, the support shaft(s) 644 couple to the arms 52b, 52c of the first frame member 52, either in the side of, above or below the arms 52b, 52c. The support shaft(s) 644 allow the pedal 64 to articulate or pivot when the engagement area 640 is depressed downwardly, wherein the hollow portion of the T-shapes tube 642 is freely urged about the support shaft(s) 644. A spring assembly 70 is coupled to the first frame member 12 and the T-shaped tube 642, generally near the junction of the stem 52a and the arms 52b, 52c. The spring assembly 70 comprises an inwardly biased spring 702 having an end of the spring 704 coupled to the T-shaped tube 642 and having an opposing end of the spring 706 coupled to a suspended yoke 708. If the engagement area 640 is depressed, the T-shaped tube 642 urges the spring 702 to expand, and upon release of the engagement area 640, the inward bias of the spring 702, coupled to the suspended yoke 708, operate to return the T-shaped tube 642, and pedal 64, to position.

The support 56 may comprise one or more struts 56a, 56b. At or near the top of the strut(s), a horizontal bar 74 is coupled to an index guide 72. The index guide 72 may be coupled to the support 56 or may be coupled to the second frame member 54 (as depicted). In one embodiment, as depicted in FIG. 1, FIG. 5 and FIG. 6, the index guide 72 comprises a plurality of index recesses 720 vertically aligned for adjusting the relative height of the rear of the second frame member 54. Once an index recess is selected, and the bar 74 is placed therein, thereby raising or lowering the rear-height of the second frame member 54 relative to its previous position, a lock 722 may be utilized to prevent the bar 74 from slipping from the recess 720. The lock 722 may comprise a variety of mechanisms, or combinations of mechanisms, including hand-turned impingement devices, or the use of cotter pins or keys, and the like.

In another embodiment, as depicted in FIG. 7, the index guide 72 comprises a plurality of index apertures 721 formed on the struts 56a, 56b, wherein each aperture of one strut 56a is coaxially aligned with an aperture of the other strut 56b. A centrally and vertically aligned post 723 is coupled with the struts 56a, 56b via a fastener or bar 725, the post 723 intermediately disposed between the struts 56a, 56b. The post 723 is coupled to the second frame member 54 via a stump 727 received in the upper terminus of the post 723, the post 723 and stump 727 each having an aligned aperture therethrough. A pin 729 or other similar device may be inserted through the apertures to secure the post 723 with stump 727, thereby interconnecting the first frame member 52, the struts 56a, 56b and second frame member 54, respectively. The fastener 725 may articulate, pivot or swivel, thereby urging the post 723 to do the same, in response to movement of the second frame member 54 relative to the struts 56a, 56b. Additionally, to disassemble and store the apparatus 50, the pin 729 is removed from the post 723 and stump 727, and the struts 56a, 56b are then freely articulated into a position adjacent the first frame member 52, thereby allowing the second frame member 54 to also articulate into a similar position.

In one embodiment, the first frame member 52 comprises a clamp 76 for receiving and/or retaining the bottom end of the support 56. Much like the opposing end, the lower end of the support 56 may have a horizontal bar that is inserted into the clamp 76 and secured therein. The bar may be secured into place by a hand-turned impingement device, cotter pins or keys, or similar items, as described above. It is envisioned that the clamp 76 may be open or closed. In an open configuration, the clamp 76 may have a C- or G-shape, with the bar inserted below the lip of the C- or G-shape. In a closed configuration, the clamp 76 may have a barrier, such as a pivoting clip (e.g. similar to a karabiner clip), with the bar forcibly inserted therein and secured by the lock. In either embodiment, the lower bar may be removed from the clamp, and the support 56 urged into a position substantially adjacent and parallel to the second frame member 54, thereby permitting the second frame member 54 to substantially fold onto the first frame member 52. This collapsible feature permits the user to neatly store the apparatus 50 in place or on a hook, and reduces the physical footprint of the apparatus 50 when not in use.

Similar to the first frame member 52, the second frame member 54 generally comprises a Y-shape, with the stem 54a forming the rear-portion of the member 54, and the two arms 54b, 54c depending from the stem 54a forming the front-portion of the member 54. There are a plurality of ways to form the Y-shape second frame member 54. In one embodiment, each of the arms 54b, 54c comprises a linearly elongated member terminating in flanges 78 and 80 at opposing ends of the linearly elongated member. One flange 78 may be coupled with the first frame member 52, and may further be coupled to the frame member 52 via a tree 82 having one or more collars. At an opposing end, the flange 80 (with indexing apertures) may be coupled to the stem 54a. The flange 80 may also be coupled with the flange 80 on the other arm (54b or 54c). In assembling and coupling the second frame member 54 in this manner, the member 54 more readily responds to the pedal 64 if depressed—the stem 54a pivots from the index guide 72 (described below), and the arms 54b, 54c pivot from the trees 82, with the junction of the stem 54a and arms 54b, 54c deflecting downwardly in response, thereby lowering the end of the tool or implement as needed or desired. At the junction of the stem 54a and arms 54b, 54c, the stem 54a may comprise a transverse tube 84 through which a fastener 86 (including a mechanical pin) may be used to couple the stem 54a to the rearward terminus of each of the arms 54b and 54c. The utilization of the transverse tube 84 and fastener 86 facilitates articulation or movement of the second frame member 54 in response to pedal 64 movement.

The index guide 72 downwardly depends from the stem 54a. Above the index guide 72 is a U-shaped member 88 having a retractable post 90. The U-shaped member 88 and retractable post 90 cooperatively receive and retain a first mechanical coupler 58 retaining a segment of the tool or implement. A second mechanical coupler 60 retains another segment of the tool or implement and is coupled to the stem 54a near the forward terminus of the stem 54a.

As depicted in FIG. 11, the first mechanical coupler 58 comprises a cover segment 582 and a base segment 584. The base segment 584 may have a relief 586 for receiving and housing the shaft of a tool or implement. The cover segment 582 may be free from the base segment 584, and coupled thereto via mechanical fasteners. Alternatively, the cover segment 582 may be coupled to the base segment 584 via a hinge or pivot, and further secured therewith via mechanical fastener(s). The cover segment 582 may have a relief 588 similar to that of the base segment for receiving and housing the shaft of a tool or implement. The relief 586 and relief 588 cooperatively form an aperture through which the shaft of the tool or implement may pass through but remain firmly and securely retained.

On the underside of the base segment 584, a channel 581 is formed complementary to the retractable post 90. The retractable post 90 comprises a top 902 and an elongated post 904 having a boss 906, and an outwardly biased spring 908 retaining the post 90 in position. Within the channel 581, the width is varied so that one segment of the channel 581 is wider than the adjacent segment, and with the wider segment gradually tapering to the smaller segment. The wider segment of the channel 581 corresponds to the smaller diameter of the post 90, while the smaller segment of the channel 581 corresponds to the larger diameter of the boss 906. Therefore, the boss 906 is impinged within the smaller segment of the channel 581, wherein the smaller segment is just large enough to accept and impinge the boss 906 therein.

Thus, the first mechanical coupler 58 is secured near the rearward end of the stem 54a by frictional impingement of the channel 581 onto the post 90, and more particularly, the smaller segment of the channel 581 impinging the boss 906 of the post 90. To release the first mechanical coupler 58 from the stem 54a, the top 902 of the post 90 is 906 outwardly urged against the outward bias of the spring 908, urging the boss and exiting the channel 581, thereby releasing the channel 581 from the post 90.

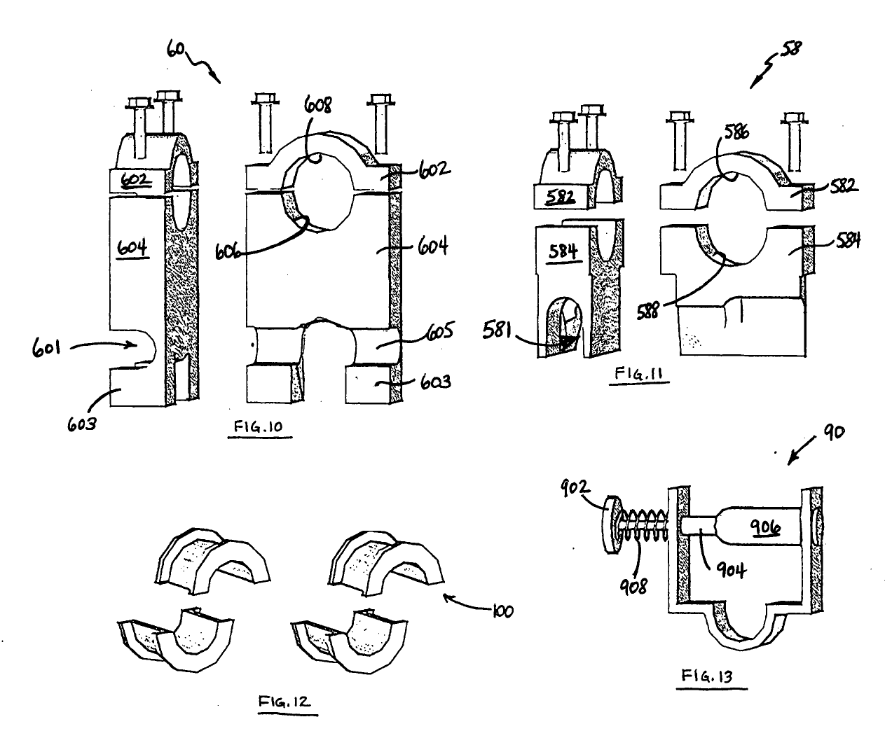

Similar to the first mechanical coupler 58, the second mechanical coupler 60 comprises a cover segment 602 and a base segment 604, as depicted in FIG. 10. The base segment 604 may have a relief 606 for receiving and housing the shaft of a tool or implement. The cover segment 602 may be free from the base segment 604, and coupled thereto via mechanical fasteners. Alternatively, the cover segment 602 may be coupled to the base segment 604 via a hinge or pivot. The cover segment 602 may have a relief 608 similar to that of the base segment for receiving and housing the shaft of a tool or implement. The relief 606 and relief 608 cooperatively form an aperture through which the shaft of the tool or implement may pass through but remain firmly and securely retained.

On the underside of the second mechanical coupler 60, and its base segment 604, an opening 601 is formed for receiving an end of the stem 54a near the junction between the stem 54a and arms 54b, 54c. The stem 54a may be further secured by a variety of mechanisms, including the use of a slidable guard. As depicted, one alternative manner is to provide one or more legs 603 having orifices 605 (aligned perpendicular to the axis of the opening 601) for receiving a similarly aligned mechanical fastener.

In the embodiment(s) depicted, and the combinations and subcombinations envisioned, the second mechanical coupler 60 is generally the first on and last off, or first coupled to the stem 54a, followed by the coupling of the first mechanical coupler 58 at the opposing end. Then, to remove, the first mechanical coupler 58 is released and removed followed by the second mechanical coupler 60. As depicted in FIG. 12, one or more collars 100 may be provided, the collars 100 having a pliable and flexible consistency, and providing sufficient resistance and rigidity to firmly and securely house the shaft of a tool or implement placed therein. The collars 100 are envisioned to accommodate a variety of diameters of shaft sizes. It is further envisioned that alternative collars 100 may be provided to narrow or widen the effective diameter formed within the collars when two are mated together. In the embodiment depicted, the collars 100 have two halves that are mirror images of one another. In another embodiment, the collars 100 may comprise an annular ring (and not halves as shown).

The stem 54a further comprises a first pair of wings 92 and a second pair of wings 94. The wings 92 and 94 are provided to operate in conjunction with the handle 62. As depicted in FIG. 1, FIG. 2 or FIG. 3, the handle 62 comprises an elongated rod 620 coupled to the stem 54a of the second frame member 54 at one end, and having a grip 622 at the opposing free end. The wings 92 and 94 extend from the stem 54a, so that the first pair of wings 92 has right and left hand mounts at a position near the rearward end, and the second pair of wings 94 also has right and left hand mounts at a position closer to the frontward end of the stem 54a. The handle 62 is coupled to the member 54 (and stem 54a) at the second wing 94, and may be coupled as either a right-handed handle or a left-handed handle. A boom 624 is coupled to the handle 62 along the rod 620, approximately one-third of the distance from the grip 622. The boom 624 is also coupled to the member 54 (and stem 54a) via a sleeve 626 and lock 628 inserted through the first wing 92, which may also be coupled as right-handed or left-handed. As the rod 620 is moved away from the member 54 (and stem 54a), the boom 624 is urged outwardly through the sleeve 626, with the sleeve 626 slightly rotating from an orientation that is generally parallel to the stem 54a to a position that is substantially perpendicular to the stem 54a (using the bore through the sleeve 626 as a reference point). A stop 629 at the end of boom 624 prevents the boom from exiting the sleeve, and generally corresponds to having the handle 62 fully extended from the member 54 (and stem 54a).

As depicted in FIG. 2, the handle 62 may further include an additional elongated rod 625 providing additional stabilizing support to the handle 62. The rod 625 is coupled to the rod 620 near the coupling of the boom 624 to the rod 620. The rod 625 is coupled to the first frame member 52 preferably at the stem 52a, or the elongated members that form the stem 52a. The rod 625 is secured to the frame member 52 via a pair of upstanding wings 96 retaining a pair of articulating wings 98 via a transverse bolt or fastener 99. The pair of articulating wings 98 permits the rod 625 to be attached as a right-handed or left-handed element corresponding to the attachment of the handle 62 (right or left handed).

A control 66 may be included, disposed between the T-shaped tube 642 of the pedal 640 and one of the arms 54b or 54c of the second frame member 54. The control 66 comprises two telescoping bodies 662 and 664. Along the upper body 662, the control 66 may be coupled to a flange of one of the arms 54b or 54c via a collar formed on the body 664 and a mechanical fastener and nut. Similarly, along the lower body 664, the control 66 may be coupled to a billet 665 projecting from both sides of the T-shaped tube 642. The end of the lower body 664 may be secured in place by mechanical fastener and nut, or by cotter pin or key, or other similar mechanisms. The upper body 662 includes a crank 668 for rotating the threads for raising and lowering the relative height of the tool or implement. In this embodiment, the control 66 serves multiple purposes, including use as a fine adjustment means of the tool or implement. In addition, the control 66 interconnects the pedal 64 and T-shaped tube 642 to the arm(s) 54b or 54c of the second frame member 54, so that when the pedal 64 is depressed, and the T-shaped tube 642 articulates or pivots downward, the T-shaped tube 642 also urges the control 66, and therefore the arms 54b, 54c, downwardly as well. This is particularly advantageous when the apparatus 50 is used to support a grass-cutting tool, such as a weed trimmer. Since many weed trimmers require the user to strike the spool-holder a surface to advance the spool line, usually striking the spool-holder directly on the ground, the user of the apparatus 50 can depress the pedal 64 so that the weed trimmer (and spool-holder) strike the surface and advance the trimmer line when necessary. This avoids the user having to awkwardly manipulate the apparatus 50, or otherwise remove the trimmer, from the apparatus 50, to advance the trimmer line.

An example of assembly and use may further explain the elements of the apparatus 50 disclosed herein. The apparatus 50 may be found in a disassembled and collapsed (stored) form. To reassemble for use, the second frame member 54 may be raised so that its rear terminus is generally higher than the front terminus, and the support 56 moved to a substantially vertical alignment and positioned to generally support the rear terminus of the member 54. Any locking mechanism utilized at the upper and lower termini of the support 56 to secure the first frame member 52 and support 56, and second frame member 54 and support 56, respectively, are manipulated to secure the members 52 and 54 and support 56 into place. The mechanical couplers 58 and 60 are then secured to the tool or implement, which in this example is a weed trimmer (but could be other shafted-devices). Usually, the cover segment 582 is removed or manipulated to expose the reliefs 586 and 588 formed in the cover 582 and the base 584, whereby the shaft of the tool or implement may be positioned therein. After placement of the shaft, the cover 582 is re-coupled to the base 584, and is repeated for the other mechanical coupler 58 or 60. Thereafter, the couplers 58 and 60 are secured to the stem 54a of member 54, usually with the second mechanical coupler 58 first coupled to the stem 54a, and the first mechanical coupler 58 the last coupled thereto. Then, the handle 62 is extended from the second frame member 14 and locked into position. Alternatively, if a user wanted to change the handle position from one hand to another, the wings 92 and wings 94 would allow such a change to be performed effortlessly and quickly. The user may then adjust the height of the tool or implement via the control 66. Thereafter, the tool or implement may be started and used, with the apparatus 50 supporting the tool or implement and facilitating easy movement of the tool or implement about a work area, and especially along inclines or embankments or rough and uneven surfaces.

It is to be understood that the embodiments and claims are not limited in its application to the details of construction and arrangement of the components set forth in the description and illustrated in the drawings. Rather, the description and the drawings provide examples of the embodiments envisioned, but the claims are not limited to the specific embodiments. The embodiments and claims disclosed herein are further capable of other embodiments and of being practiced and carried out in various ways, including various combinations and subcombinations that may not have been explicitly disclosed. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claimed appended hereto.

What is claimed is:

1. A mobile carriage for a tool comprising:
a first frame and a second frame;
a support coupling the first frame and the second frame, the support elevating an end of the second frame;
at least one retaining member positioned along the second frame, the at least one retaining member retaining the tool;
a plurality of moving means positioned at terminal ends of the first frame;
a handle depending from one of the first frame or the second frame; and
a control altering the vertical distance between the first frame and the second frame.

2. The mobile carriage of claim 1, wherein each of the first frame and the second frame comprises a Y-shape.

3. The mobile carriage of claim 2, wherein each of the first frame and the second frame has a plurality of indexing apertures for selectively adjusting the length of each frame.

4. The mobile carriage of claim 1, wherein the support comprises an indexing guide having a plurality of indices vertically aligned to receive a bar depending from the second frame.

5. The mobile carriage of claim 4, wherein the support comprises a pair of struts and a transverse bar supported by the struts.

6. The mobile carriage of claim 5, wherein the transverse bar is received through one of a plurality of indices formed in a centrally aligned post.

7. The mobile carriage of claim 5, wherein the transverse bar is received through one of a plurality of indices formed in struts.

8. The mobile carriage of claim 1, wherein the at least one retaining member comprises a base segment and a cover segment, each segment having a relief receiving the shaft of the tool, the base segment and the cover segment coupled to one another.

9. The mobile carriage of claim 8, wherein the at least one retaining member comprises a channel formed in the underside thereof receiving a retractable post, wherein the diameter is tapered.

10. The mobile carriage of claim 9, wherein the retractable post comprises an elongated post having a boss and an outwardly biased spring retaining the post in position, the elongated post having a tapered form.

11. The mobile carriage of claim 10, wherein the smaller diameter portion of the channel retains the wider diameter portion of the elongated post, thereby retaining the retractable post therein, wherein the retractable post is urged against the outwardly biased spring to urge the wider diameter portion from the channel, thereby releasing the at least one retaining member from the second frame.

12. The mobile carriage of claim 8 further comprising a second retaining member, the second retaining member comprising a base segment and a cover segment, each segment having a relief receiving the shaft of the tool, and having at least one leg and one opening for coupling with a transverse fastener coupling a pair of arms of the second frame.

13. The mobile carriage of claim 1, wherein the handle comprises a boom coupled to the second frame via a sleeve and lock inserted through a first pair of wings having right handed and left handed elements, and an elongated rod coupled to the second frame at a second pair of wings having right handed and left handed elements.

14. The mobile carriage of claim 13, wherein the handle comprises a second elongated rod coupled to the first frame via a pair of upstanding wings and a pair of articulating wings, the pair of articulating wings having right handed and left handed elements.

15. The mobile carriage of claim 1, wherein the control comprises two telescoping bodies interconnected between the first frame and the second frame, the control having a crank communicating with a threaded member for raising and lowering the profile of the second frame relative to the first frame.

16. The mobile carriage of claim 1 further comprising a pedal for downwardly urging a terminal end of the tool.

17. The mobile carriage of claim 16, wherein the pedal comprises an engagement area formed at an end of a linearly elongated T-shaped tube, the T-shaped tube coupled with at least one support shaft, the at least one support shaft coupled to a pair of arms of the first frame, the pedal articulating downward about the at least one support shaft.

18. The mobile carriage of claim 17 further comprising a spring assembly coupled to the first frame and the T-shaped tube, the spring assembly having an inwardly biased spring having an end of the spring coupled to the T-shaped tube and having an opposing end of the spring coupled to a suspended yoke.

19. The mobile carriage of claim 1, wherein the plurality of moving means comprises at least one wheel coupled to each terminal end of the first frame.
